(19) United States
(12) Patent Application Publication
(10) Pub. No.: US 2012/0032477 A1
(43) Pub. Date: Feb. 9, 2012

(54) CHARACTER FORM CHILD SEAT

(75) Inventors: Brent Cymbalski, Chesterfield, MI (US); Mitchell Prine, West Palm Beach, FL (US)

(73) Assignee: Inspired Design Group, LLC, West Palm Beach, FL (US)

(21) Appl. No.: 13/081,481

(22) Filed: Apr. 6, 2011

Related U.S. Application Data
(63) Continuation-in-part of application No. 11/428,551, filed on Jul. 4, 2006, now Pat. No. 7,942,478.

(51) Int. Cl. B60N 2/26; A47D 15/00; B62B 7/12; A47B 83/02; B60R 22/10; A63G 9/10; A47C 7/62

(52) U.S. Cl. 297/135; 297/250.1; 297/181; 297/188.08; 280/30

(57) ABSTRACT

The present invention provides a child seat system comprising a character form seat body having and an adjustable head rest. A wheel base, capable of functioning as a child stroller and a leg base, capable of functioning as a high chair are also provided.

The present application claims priority to U.S. application Ser. No. 11/428,551, filed on Jul. 4, 2006, which is hereby incorporated by reference in its entirety.

### FIELD OF THE INVENTION

The above-identified invention involves the field of a child seats in general and specifically relates to a character form child car seat, character form child stroller and character form high chair system.

### BACKGROUND OF THE INVENTION

Young children are generally restrained in an automobile, by government decree, in specially designed forward or rearward facing seats that are, in turn, secured to the regular vehicle seat using integral vehicle seat belts. Young children are often transported in strollers, which may be combination devices comprised of a child car safety seat and a wheel base. Similarly young children are often seated in high chairs, which may be combination devices comprised of a child seat and a leg base.

Child car seats are well known in the art and have been well described using a variety of methods and systems for effecting child restraint. Full integral seat belt restraint systems have been incorporated into some seats, while others act as “booster” seats, utilizing the seat belt restrain system that is part of the vehicle, simply lifting the child into a suitable position.

Child strollers, high chairs and combination devices, wherein a child seat is combined with a stroller or high chair are also well known in the art.

Two pervasive difficulties remain in effectively using a child car seat. First involves non-cooperative children who squirm and move, making “seating” the child difficult and in the case of car seats, preventing effective tightening of the seat belt restraint system. Second is effective and rapid removal of a child from the seat in the event of an accident or other emergency.

Safety restrain belt systems are widely used and are well described in the art. However, the prior art fails to provide an effective, easy and rapid means for removal of a child from the seat in the event of accident or other emergency. The means of the prior art is often complicated, awkward and time consuming, requiring more than one single operation in the process of release.

Security is also a significant requirement, and the quick release system cannot be vulnerable to accidental release or easy manipulation by the child in the seat. According to the present invention, the quick release system lever is position on the back surface of the seat, easily accessible to an adult for rapid extraction of the child, but unavailable to a child's probing hands and insatiable curiosity. Moreover, a vertical/horizontal channel locking system and the requirement for lateral rod removal precludes accidental release.

The present invention provides an appealing and comfortable setting for the child, thereby solving the first problem. The present invention further provides an rapid seat belt restrain release system, thereby solving the second problem.

The present invention provides distinct advantages over the prior art and solves numerous problems described and understood in the field.

### SUMMARY OF THE INVENTION

It is therefore an object of the present invention to provide a child seat adapted to have a child seated therein, the child car seat comprising: (a) a seat body having (i) a seat wall and a backrest wall; (ii) a seat body front seat side; (iii) a seat body back side; (iv) a seat body top side, wherein the seat body top side further comprises a vertical channel, having a channel upper end and a channel lower end; (v) a bottom side; (vi) a left side; and (vii) a right side; wherein a juvenile sitting in the seat body is embraced by the front seat side, the bottom side, the left side and the right side; and (b) a head rest, the head rest capable of cradling a juvenile head comprising (i) a head rest left side head support; (ii) a head rest right side head support; (iii) a headrest top side; (iv) a head rest bottom side; (v) a head rest central region, situated approximately between the horizontal position of the head rest left side head support and the head rest right side head support; and (vi) a head rest body insertion post, the head rest body insertion post comprising: (i) an elongated insertion end extending downward from the head rest bottom side, wherein the elongated insertion end is capable of reversibly inserting into the seat body top side.

Moreover, it is a further object of the present invention to provide the seat with a wheel base, capable of functioning as a child stroller. Still further it is another object of the present invention to provide the seat with a leg base, capable of functioning as a high chair.

### BRIEF DESCRIPTION OF THE DRAWINGS

FIG. 1A shows a perspective view of the seat in accordance with the present invention. FIG. 1B shows a perspective view of the seat body and the seat head rest.

FIG. 2 shows a front view of the seat in accordance with the present invention.

FIG. 3 shows a side view of the device in accordance with the present invention.

FIG. 4 shows a rear view of the device in accordance with the present invention.

FIG. 5 shows a top view of the device in accordance with the present invention.

FIG. 6 shows a bottom view of the device in accordance with the present invention.

FIG. 7 shows a rear perspective view of the seat in accordance with the present invention.

FIG. 8A shows a front view of a preferred embodiment of the seat. FIG. 8B shows a rear view of a preferred embodiment of the seat. FIG. 8C shows a top view of a preferred embodiment of the seat. FIG. 8D shows a bottom view of a preferred embodiment of the seat. FIG. 8E shows the quick release seat belt system. FIG. 8F shows a close up of the quick release seat belt system.

FIG. 9 shows a perspective view of the seat with an insertable accessory device in an alternative embodiment.

FIG. 10 shows a side view of the seat configured as a high chair.

FIG. 11 shows a side view of the seat configured as a stroller.

### DETAILED DESCRIPTION OF THE INVENTION

The present invention provides a child seat adapted to have a child seated therein, the child car seat comprising: (a) a seat body having (i) a seat wall and a backrest wall; (ii) a seat body front seat side; (iii) a seat body back side; (iv) a seat body top side, wherein the seat body top side further comprises a vertical channel, having a channel upper end and a channel lower end; (v) a bottom side; (vi) a left side; and (vii) a right side; wherein a juvenile sitting in the seat body is embraced by the front seat side, the bottom side, the left side and the right side; and (b) a head rest, the head rest capable of cradling a juvenile head comprising (i) a head rest left side head support; (ii) a head rest right side head support; (iii) a head rest top side; (iv) a head rest bottom side; (v) a head rest central region, situated approximately between the horizontal position of the head rest left side head support and the head rest right side head support; and (vi) a head rest body insertion post, the head rest body insertion post comprising: (i) an elongated insertion end extending downward from the head rest bottom side, wherein the elongated insertion end is capable of reversibly inserting into the seat body top side. According to a preferred embodiment of this present invention, the head rest is adjustable in the vertical plane.

According to one embodiment of the present invention, the seat is a character form child seat, wherein the seat body is further comprising a generally recognizable character body, head and arm shape. According to another embodiment, the seat body is further comprising at least one arm rest having a generally recognizable character arm shape, the arm rest terminating in a cup holder having a generally recognizable character first shape, the cup holder capable of receivably accepting a geometrically shaped object.

The present invention provides a “character” form seat. The term “character” is used herein to describe a physical form representation, including a human form, animal form, cartoon character form, mythological character form, whether specifically representative of an individual human, animal or other character. It is to be understood that the seat itself takes on a representative form and that the seat will be most often used with a seat cover, comprised of cloth, plastic or other natural or synthetic material that may have printing or coloring or filling to more accurately depict a particular character or character type. It is specifically contemplated that the seat cover may be removable.

According to one embodiment of the present invention, the seat body shape generally comprises the form of a cartoon character. Numerous cartoon characters are well known from comics, television and movies. Lists of cartoon characters are omnipresent in the literature, which are incorporated hereto by reference. Other cultural icons, toys, dolls and action figures are also specifically contemplated. The present invention specifically contemplates the use of any human, animal, cartoon or any other recognizable or unrecognizable character as the character form for the seat.

According to an alternative embodiment of the present invention, the generally human body shape is a representation of an actual person. The actual person may be a public figure, such as a politician, sports figure, actor, cultural figure, religious figure, historical figure or scientist. Alternatively, the actual person may be a private individual, such as the child typically using the seat, or another family member. According to yet another alternative embodiment, the individual is a generic person such as a child, mother or father. According to yet still another alternative embodiment, the individual is an animal.

According to still another embodiment, the head rest body insertion post further comprises a vertical channel through at least a portion of the elongated insertion end, capable of transmitting there through an anchor belt. The anchor belt is well known in the art and is used to stabilize the seat when positioned in a car. Also known as a tether strap or tether belt, the anchor belt is often part of LATCH (lower anchor and tethers for children) type securing systems. The present invention, by threading the anchor belt through a vertically adjustable head rest, creates a more stable seat in conjunction with a properly secured anchor belt such as with a LATCH system. By having the topmost point of the anchor belt move with the head rest, the present invention provides a distinct advantage over the prior art and thereby limits lateral movement of the seat. According to this preferred embodiment, the position of the body insertion post in the top side of the seat body is adjustable in the vertical plane. According to still another preferred embodiment, the body insertion post further comprises an insertion post vertical adjustment locking means. Such locking means are contemplated to include numerous variations such as deformable, inserting buttons, fasteners of all types, spring-loaded pins and the like. According to a most preferred embodiment, the seat body further comprises a vertical channel, having a channel upper end and a channel lower end, the vertical channel capable of receiving at least a portion of the elongated insertion end of the head rest body insertion post. According to this embodiment, the vertical channel is capable of transmitted there through an anchor belt. According to a most preferred embodiment of this invention, the seat body further comprises a plurality of vertically disposed adjustment locking apertures. These apertures are capable of stably accepting correspondence locking means such as deformable buttons present on the head rest body insertion post. According to one embodiment, the channel lower end terminates in an anchor terminus aperture, capable of receiving an anchor belt terminus. According to this embodiment, the seat end of the anchor belt is stably attached to the seat body.

According to still another embodiment of the present invention, the seat further comprising a seat base. According to one embodiment of this invention, the seat base further comprises a storage compartment. According to another embodiment, the seat base further comprises at least one cup holder.

According to another embodiment of this invention, the seat base further comprises a wheelbase attachment means. According to an alternative embodiment of the present invention, the seat body bottom side further comprises a wheelbase attachment means. The present invention contemplates numerous means to facilitate the attachment of the wheelbase to the seat body bottom side or the seat base, such as fasteners, clips, deformable inserting buttons, spring loaded or spring actuated pins and the like. According to a preferred embodiment of the present invention, a wheelbase is provided. According to a most preferred embodiment, the wheelbase has a corresponding attachment means, capable of reversibly attaching the wheelbase to the wheelbase attachment means. According to a preferred embodiment, the wheelbase is removable. When attached, the seat functions as a rolling stroller. According to one embodiment of this invention, a stroller handle is provided, capable of being attached to the either the seat body or the wheel base. According to yet another embodiment, a removable footrest capable is also provided.

According to another embodiment of this invention, the seat base further comprises a leg base attachment means. According to an alternative embodiment of the present invention, the seat body bottom side further comprises a leg base attachment means. The present invention contemplates numerous means to facilitate the attachment of the wheelbase to the seat body bottom side or the seat base, such as fasteners, clips, deformable inserting buttons, spring loaded pins and the like. According to a preferred embodiment of the present invention, a leg base is provided. According to a most preferred embodiment, the leg base has a correspondence attachment means, capable of reversibly attaching the leg base to the leg base attachment means. According to a preferred embodiment, the leg base is removable. When attached, the seat functions as a child high chair. According to one embodiment of this invention, the leg base comprises a plurality of vertically adjustable legs, thereby facilitating use of the high chair at various heights and facilitating use of the seat as an entertainment seat at lower heights. According to a preferred embodiment of this invention, the leg base height is vertically adjustable. The present invention contemplates a variety of means to effect vertical leg adjustment including with removable fasteners, deformable buttons, spring loaded pins and telescoping leg shafts. According to one alternative contemplated by the present invention, the leg base could be substituted with a rocker base for use as a rocking chair.

According to another embodiment of the present invention, the seat further comprises an insertable accessory device, wherein the insertable accessory device is mounted to the seat by removably inserting an geometrically shaped attachment object extending forth from the insertable accessory device into at least one of the arm rest cup holders. According to one embodiment of this invention, the insertable accessory device is a tray table. According to a preferred embodiment of this invention, the tray table comprises pre-molded depressed areas, suitable for stably holding cups, plates, crayons, toys and the like. According to another embodiment, the tray is horizontally adjustable in place.

According to a preferred embodiment of this invention, the geometrical shape is a cylinder. According to another preferred embodiment of this invention, the insertable accessory device is a tray table. The present invention specifically contemplates a wide variety of insertable accessory devices, including toys, games reading lights and the like. It is also understood that in some cases both arm cup holders would be needed to support the insertable accessory device. However, in other cases a single cup holder would be needed, leaving the second cup holder available to support a second insertable accessory device or to be simply used as a cup holder.

According to another embodiment of the present invention, the seat further comprises a fastenable seat restraint belt system. A variety of seat restrain belt systems have been described in the art and are suitable for use with the present invention. According to a preferred embodiment of this invention, the seat restraint belt system is a three-point belt. According to a more preferred embodiment of this invention, the seat restraint belt system is a five-point harness type belt. According to a preferred embodiment of this invention, a five-point harness is used. According to this preferred embodiment, each of the five harness straps include a rear extending and looped end through which is slidably engaged a release lever, which is in turn supported upon a plurality of locking ribs extending from the back side of the seat. Upon rotating and laterally translating and withdrawing the rod, each of the five harnesses are quickly released from engagement against the rear facing side of the seat thereby permitting the child to be quickly removed. According to a preferred embodiment of this invention, the rod is cylindrical. It is specifically contemplated by the present invention that the rod may be made from a variety of materials including wood, plastic, metal, fiberglass or composite. According to a preferred embodiment, the rod is metal. The rod is of sufficient tensile strength so that it is capable of supporting the seat belt under tension. According to another preferred embodiment of the invention, there are five locking ribs. According to one embodiment of this invention, the locking rib is integral with the seat. According to another embodiment of this invention, the locking rib is removably attached to the back of the seat by a fastening means. A fastening means includes but is not limited to a screw, bolt, rivet, and glue.

According to still yet another embodiment of the present invention, the seat further comprises a left shoulder belt aperture and a right shoulder belt aperture. The shoulder belt aperture is capable of receiving and having pass there through a seat belt. According to a preferred embodiment of the present invention, the seat belt is part of a five-point belt system. According to still yet another embodiment of the present invention, the seat further comprises a left lap belt aperture and a right lap belt aperture. The lap belt aperture is capable of receiving and having pass there through a seat belt. According to a preferred embodiment of the present invention, the seat belt is part of a five-point belt system. In addition, there is a crotch belt aperture positioned in the seat. The crotch belt aperture is capable of receiving and having pass there through a seat belt. According to a preferred embodiment of the present invention, the seat belt is part of a five-point belt system.

According to still another embodiment of the present invention, the seat further comprises a quick release seatbelt system, capable of rapidly disengaging seatbelts, enabling rapid release of a child from the seat, wherein the quick release system comprises: (a) a quick release rod, capable of horizontally inserting through the seat belt restraint system, facilitating contiguity of the seat belt restraint system, so that when the rod is horizontally removed, the seat belt restraint system is not contiguous, the rod having a handle end portion, a straight middle length and a far end portion, the handle end portion bent at an angle approximately perpendicular to the straight middle length; and (b) At least one locking rib, the locking rib comprising a block body having groove there through, capable of insertably receiving the quick release rod horizontally through the groove, wherein the groove comprises a horizontal portion and a vertical portion arranged so that the rod can be aligned in the horizontal portion of the groove in the horizontal plane, thereby preventing movement of the rod in the vertical plane. According to a preferred embodiment, the rod is cylindrical. According to another preferred embodiment of this invention, the locking rib block body is situated on the backside of the seat body in an orientation wherein the vertical portion of the groove and the horizontal portion of the groove form a “T” shape. According to a most preferred embodiment of this invention, the rod is of sufficient tensile strength so that it is capable of supporting the seat belt.

According to another embodiment of the present invention the arms are removable. According to yet another embodiment, at least one arm is adjustable in the vertical plane. According to still another embodiment, at least one arm is adjustable in the horizontal plane. According to a further embodiment, at least one head support is adjustable in the vertical plane. According to a yet a further embodiment, at least one head support is adjustable in the horizontal plane.

With respect to the storage compartment, according to another embodiment of the present invention, it is expressly contemplated by the present invention that the storage compartment may be open or enclosed. The storage compartment may be modular, enabling removal of the compartment and replacement therefore with a variety of insertable components. Stored items may be contained by a variety of means such as drawers, nettings, cords, elastic or wrappers. The storage compartment may integrate smaller compartments within the storage area. The storage compartment may include a closeable cover.

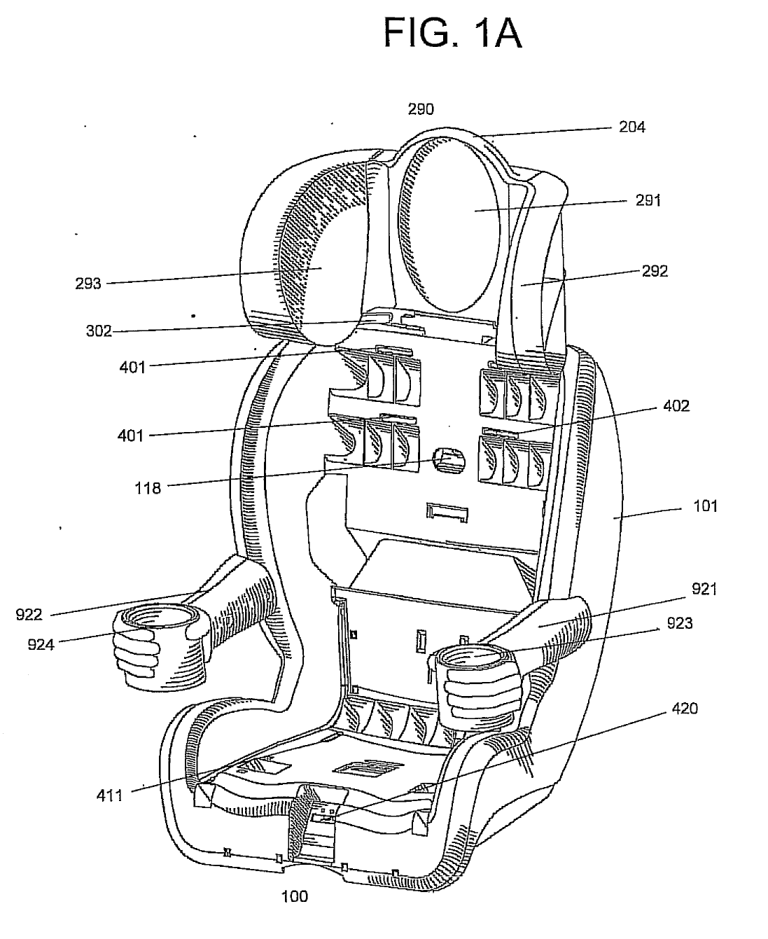

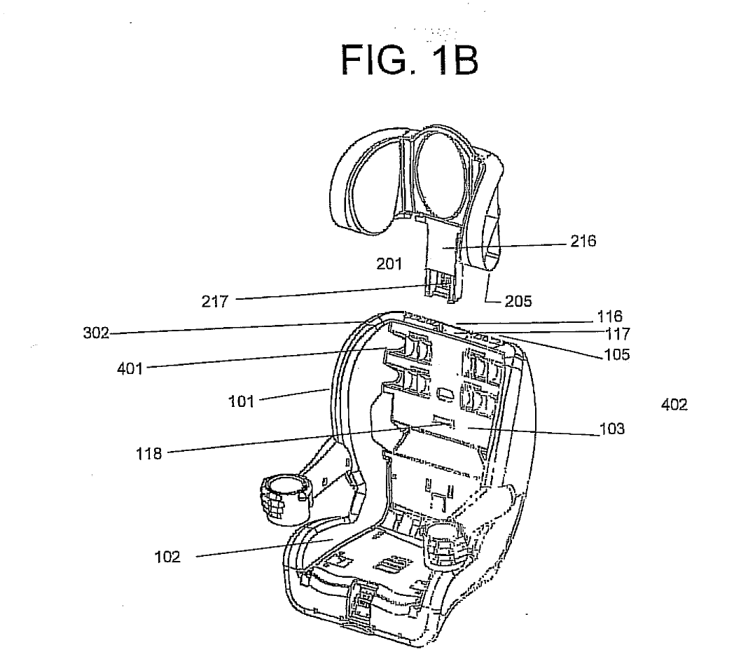

Turning now to the figures, FIG. 1A shows a perspective view of the child seat 100. The figure shows the head 290, which forms a depression 291 relative to the body of the seat, wherein the depression serves to cradle a child's head as the child leans back into the seat while in the seated position. The head depression may be covered in a cushion/pillow 299 for comfort, making the head area protrude relative to the body of the seat. Lateral to the head depression 291 is a left side head rest 292 and a right side head rest 293. As described herein, according to alternative embodiments of the present invention, the head rests are movable in the horizontal plane. Such movement is achieved by sliding means, interlocking means and pivot means as described in the prior art. The figure also shows shoulder belt apertures 302, capable of receiving and having pass there through a shoulder seat belt.

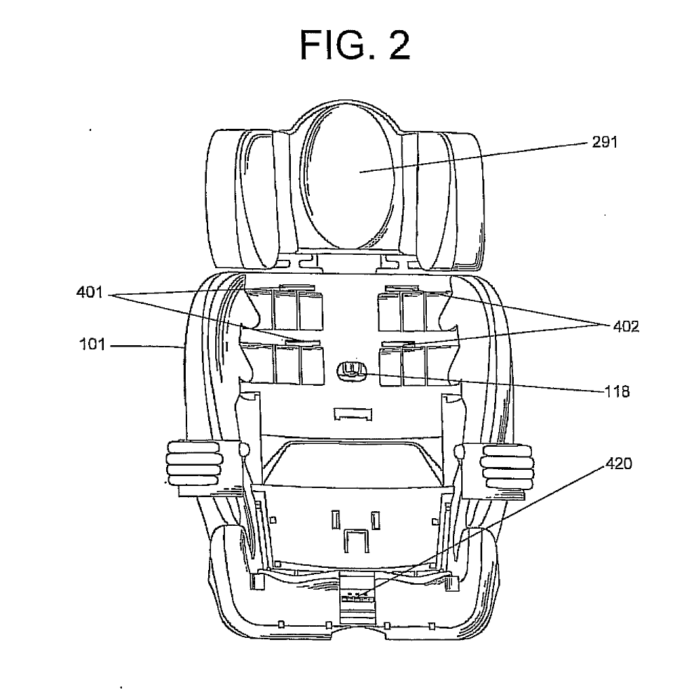

FIG. 1B shows a perspective view of the seat body 101 and the head rest 201. The seat as shown comprises (a) a seat body 101 having (i) a seat wall 102 and a backrest wall 103; (ii) a seat body front seat side; (iii) a seat body back side; (iv) a seat body top side 105, wherein the seat body top side further comprises a vertical channel 116, having a channel upper end 117 and a channel lower end 118; (v) a bottom side; (vi) a left side; and (vii) a right side; wherein a juvenile sitting in the seat body is embraced by the front seat side, the bottom side, the left side and the right side; and (b) a head rest 201, the head rest capable of cradling a juvenile head comprising (i) a head rest left side head support 202; (ii) a head rest right side head support 203; (iii) a head rest top side 204; (iv) a head rest bottom side 205; (v) a head rest central region, situated approximately between the horizontal position of the head rest left side head support and the head rest right side head support; and (vi) a head rest body insertion post 216, the head rest body insertion post comprising: (i) an elongated insertion end 217 extending downward from the head rest bottom side, wherein the elongated insertion end is capable of reversibly inserting into the seat body top side 105. As shown in FIGS. 1 and 2, and throughout the figures, the seat body is further comprising a left one arm rest 151 and a right arm rest 152, each having a generally recognizable character arm shape, the arm rest terminating in a cup holder 153, having a generally recognizable character first shape as shown with fingers 154, the cup holder capable 153 of receivably accepting a geometrically shaped object.

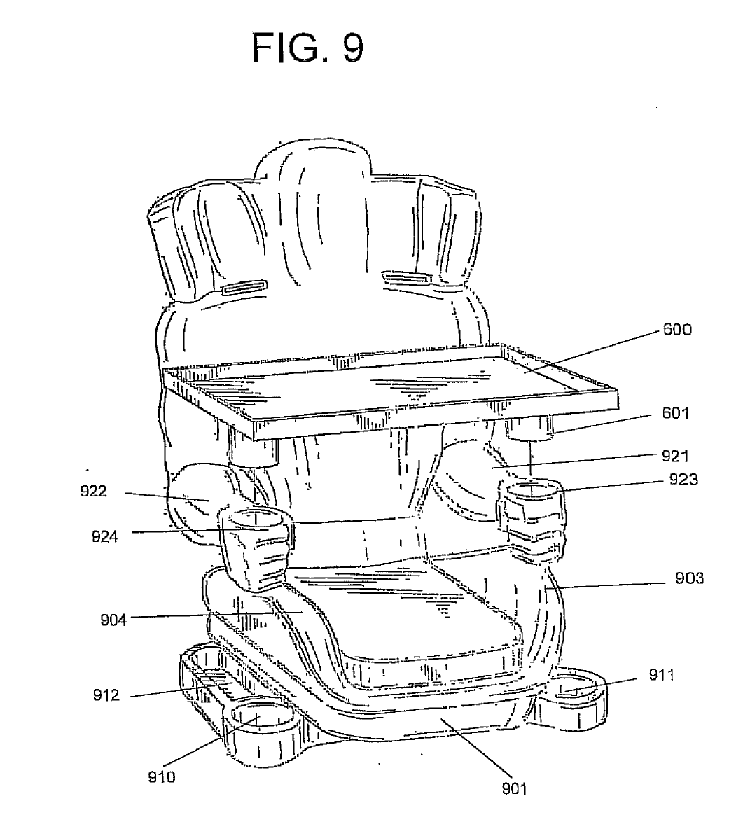

FIG. 9 shows a perspective view of an embodiment of the child seat having a base. The seat has an integral left side leg rest 903 and a right side leg rest 904. Integral with the seat base are a plurality of cup holders and storage compartments. As shown the invention provides a left seat base cup holder 910 and a right seat base cup holder 911 and a right seat base storage compartment 913 and a left seat base storage compartment 912. The embodiment also provides a left arm armrest 921 and a right arm armrest 922 as well as a left arm cup holder 923 and a right arm cup holder 924. As described herein, according to alternative embodiments of the present invention, the arm rests 921 and 922 are movable in the vertical and horizontal plane. Such movement is achieved by sliding means, interlocking means and pivot means as described in the prior art with respect to movable armrests.

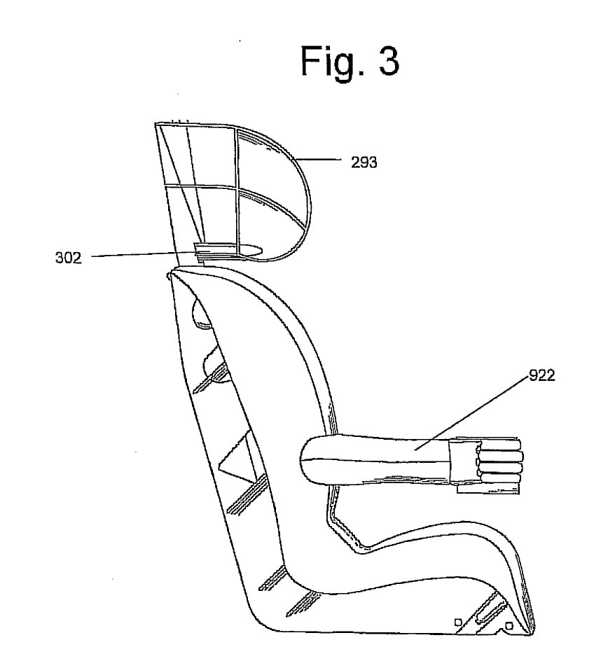

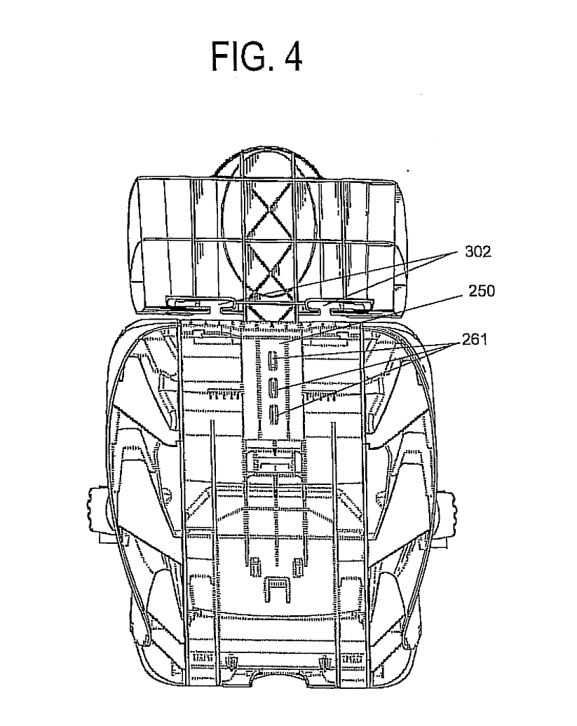

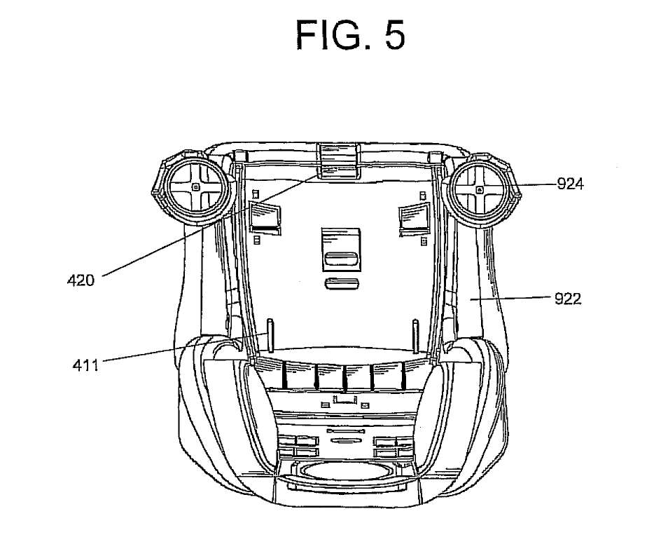

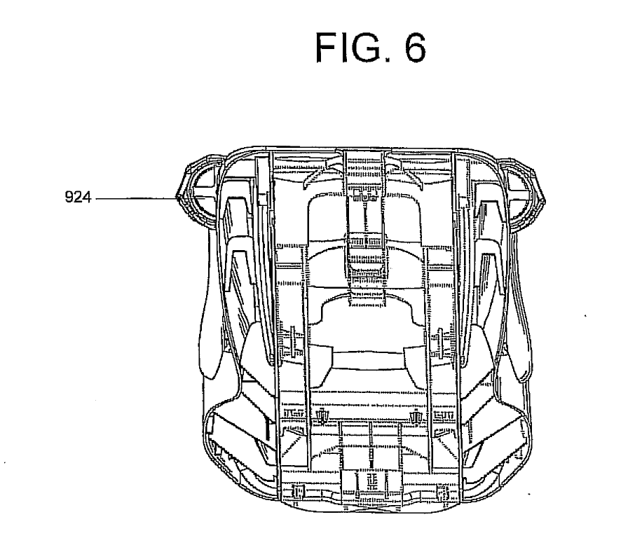

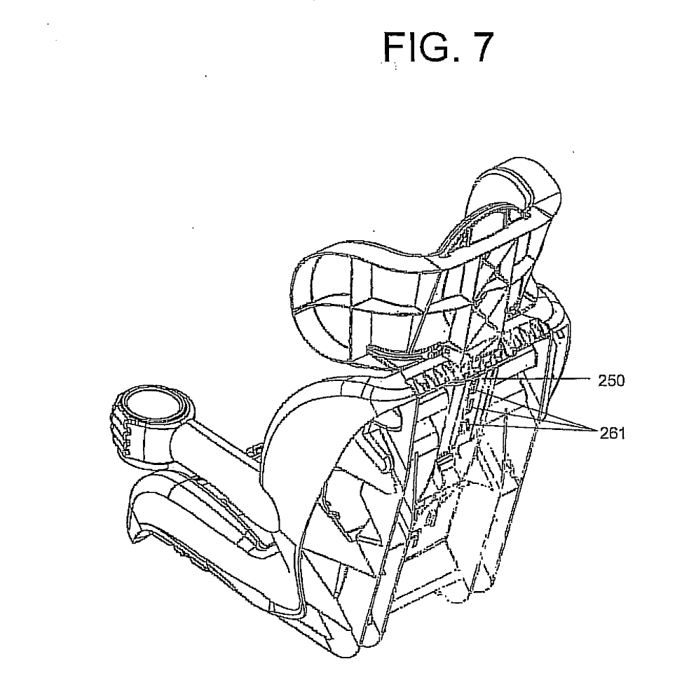

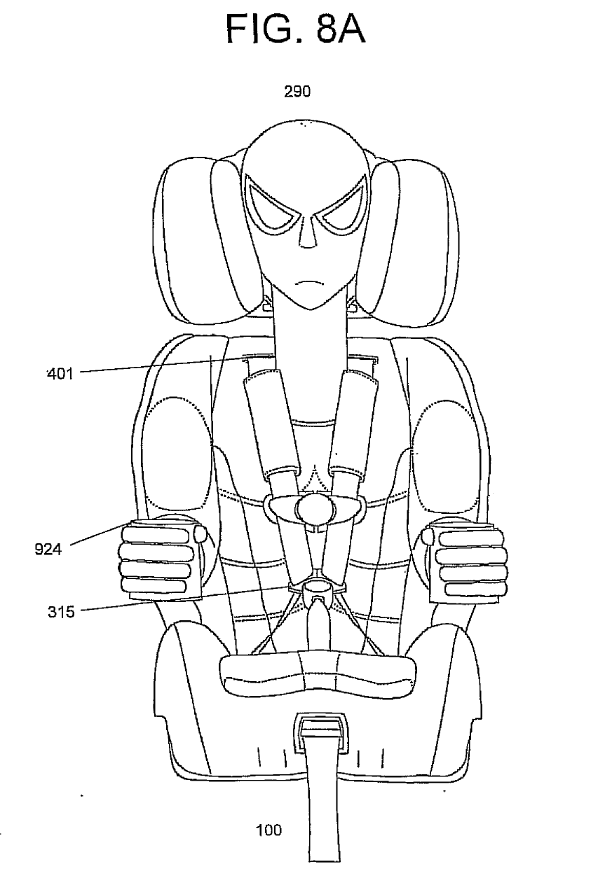

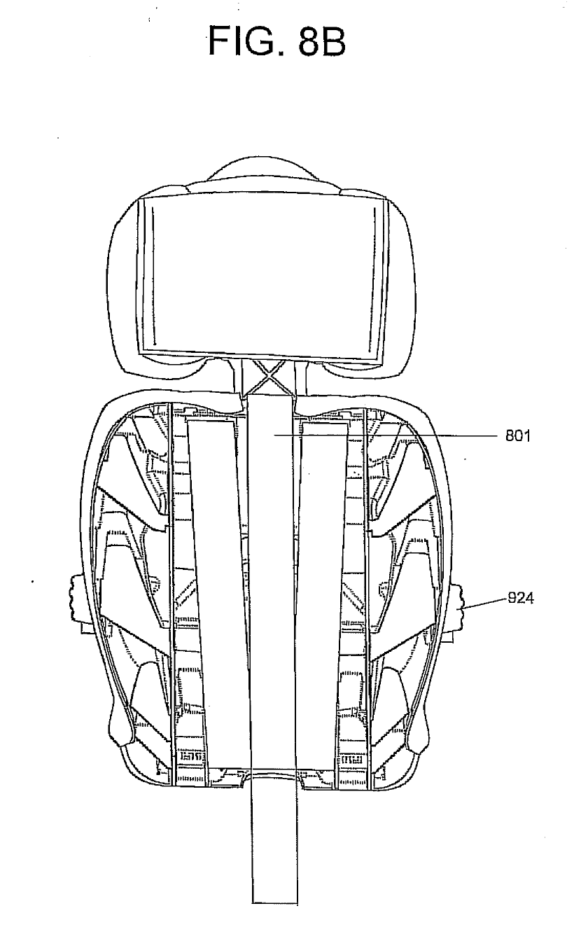

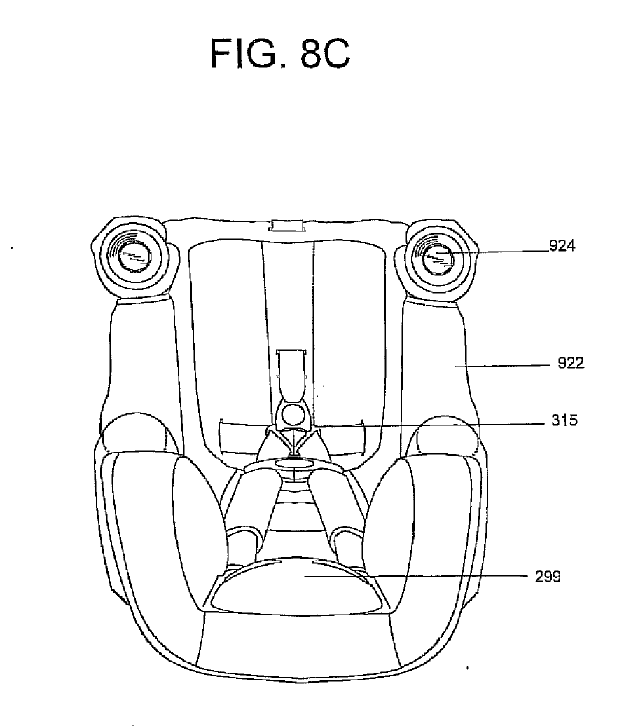

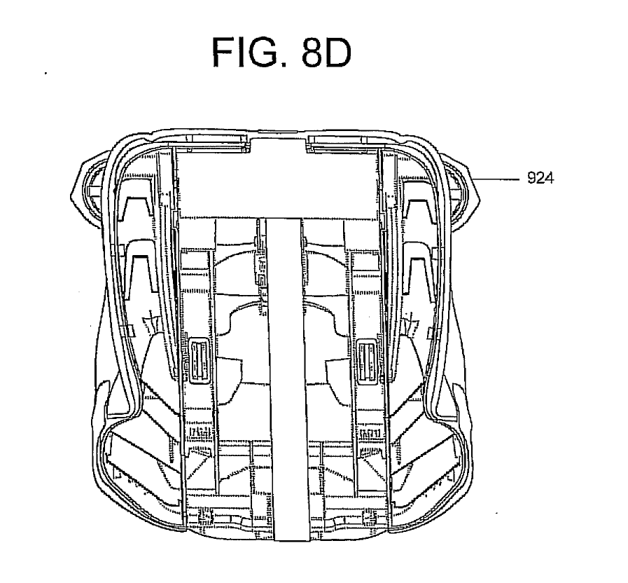

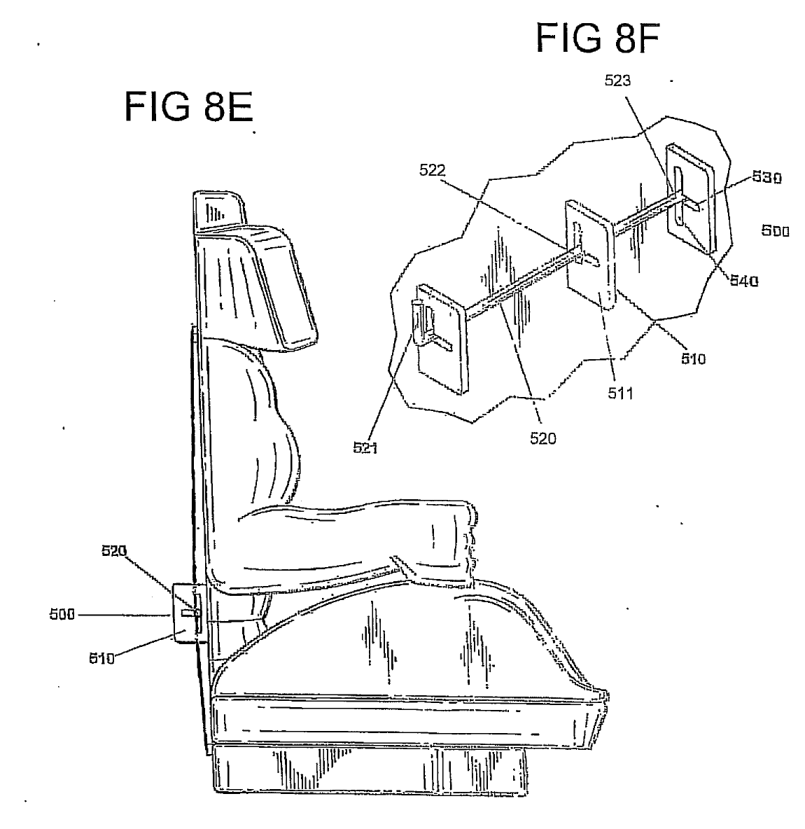

FIG. 1B shows the head rest body insertion post 216 further comprises a vertical channel 217 through at least a portion of the elongated insertion end, capable of transmitting there through an anchor belt 801. The anchor belt is exemplified as shown in FIG. 8B. As noted, the position of the body insertion post 216 in the top side 105 of the seat body 101 is adjustable in the vertical plane through the vertical channel 116. The body insertion post 216 further comprises an insertion post vertical adjustment locking means 250, exemplified in FIG. 4 and FIG. 7. As shown in top side of the seat body further comprises a vertical channel 116, shown in FIG. 1B, having a channel upper end 117 and a channel lower end 118, the vertical channel 116 capable of receiving at least a portion of the elongated insertion end of the head rest body insertion post 216. The vertical channel is capable of transmitted there through an anchor belt 801. As exemplified in FIG. 4 and FIG. 7, the seat body further comprises a plurality of vertically disposed adjustment locking apertures 261. FIG. 3 shows upper shoulder harness insertion apertures 401, 402 and lower shoulder harness insertion apertures for height adjustment of a 5-point harness, as well as the corresponding lap harness apertures 411, 412 and crotch harness aperture 420. Each harness aperture transmits a channel completely through the seat from the one side to the other side, enabling transmission of the seat belt there through as shown in FIG. 8B and FIG. 8D.

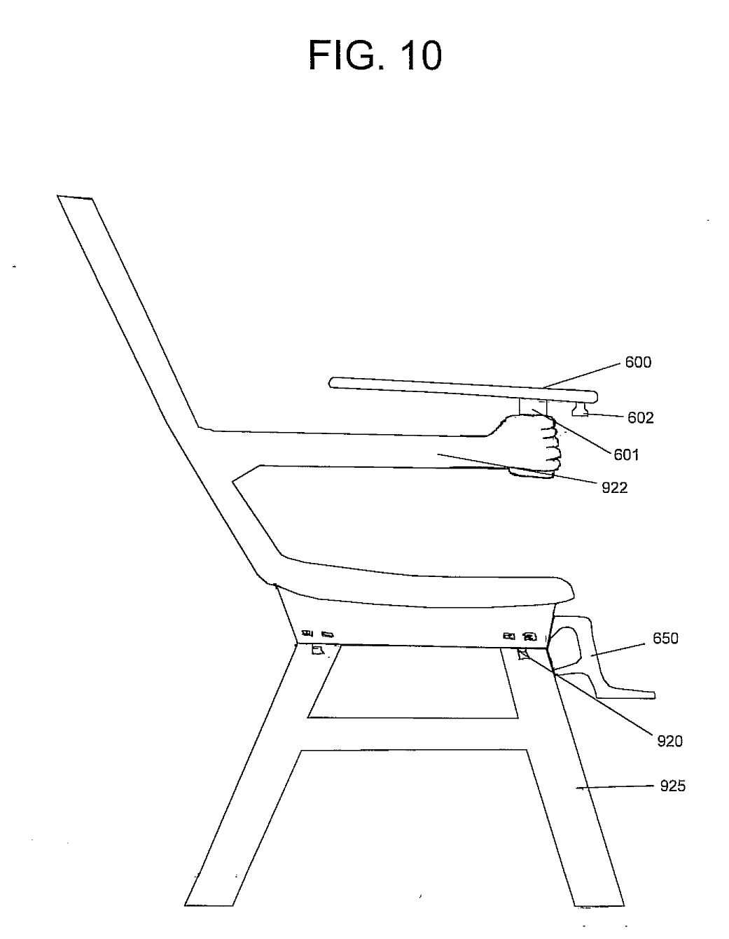

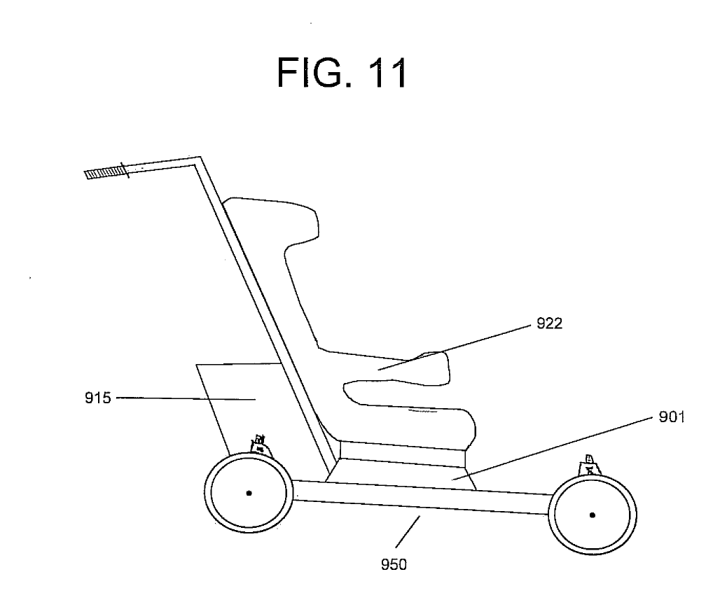

As exemplified in FIG. 9, FIG. 10 and FIG. 11, the seat further comprises a seat base 901 and storage compartments 912, 913, 915. As shown in FIG. 9, the seat base further comprises cup holders 923, 924.

According to the embodiment shown in FIG. 11, the seat base further comprises a wheelbase 950. According to another embodiment shown in FIG. 10, the seat base further comprises a leg base 925, attached by an attachment means in the form of clips 920. A removable foot rest 650 is also provided.

FIGS. 8A-F show an embodiment with a 5-point seat belt system 315. FIG. 8E further shows the quick release system 500 comprised of a plurality of locking ribs 510, a quick release rod 520. FIG. 8E shows a side view of the quick release system 500 and FIG. 8F shows a detail view of the quick release system. As shown in detail, the quick release system comprises a quick release rod 520, the quick release rod having a handle end portion 521 bent at an angle approximately perpendicular to a straight middle length 522 and a far end portion 523. The quick release rod is shown passing through a plurality of locking ribs 510, each locking rib comprising a block body 511, the block body having a T-shaped groove there through with a first groove length of the T-shape 540 in the vertical direction and a second groove length of the T-shape 530 in the horizontal direction. FIG. 9 shows a perspective view of the child seat with an insertable accessory device in a preferred embodiment.

FIG. 9 shows and embodiment of the insertable accessory device 600 as a tray table, which is mounted to the child car safety seat by removably inserting an cylindrical shaped attachment object in the form of a leg 601 extending forth from the bottom of the table into each of the arm rest cup holders. It is contemplated that the legs 601 as shown have a locking mechanism as well known in the art, to prevent the tray table from being dislodged unintentionally. A means for horizontal adjustment 602 of the tray position is also contemplated.

This invention may be embodied in other forms or carried out in other ways without departing from the spirit or essential characteristics thereof. The present disclosure is therefore to be considered as in all respects illustrative and not restrictive, the scope of the invention being indicated by the appended Claims, and all changes which come within the meaning and range of equivalency are intended to be embraced therein.

We claim:

1. A child seat adapted to have a child seated therein, the child car seat comprising:
a. a seat body having (i) a seat wall and a backrest wall; (ii) a seat body front seat side; (iii) a seat body back side; (iv) a seat body top side, wherein the seat body top side further comprises a vertical channel, having a channel upper end and a channel lower end; (v) a bottom side; (vi) a left side; and (vii) a right side; wherein a juvenile sitting in the seat body is embraced by the front seat side, the bottom side, the left side and the right side; and
b. a head rest, the head rest capable of cradling a juvenile head comprising (i) a head rest left side head support; (ii) a head rest right side head support; (iii) a head rest top side; (iv) a head rest bottom side; (v) a head rest central region, situated approximately between the horizontal position of the head rest left side head support and the head rest right side head support; and (vi) a head rest body insertion post, the head rest body insertion post comprising: (i) an elongated insertion end extending downward from the head rest bottom side, wherein the elongated insertion end is capable of reversibly inserting into the seat body top side.

2. The seat according to claim 1, wherein the seat is a character form child seat, wherein the seat body is further comprising a generally recognizable character body, head and arm shape.

3. The seat according to claim 1, wherein the seat body is further comprising at least one arm rest having a generally recognizable character arm shape, the arm rest terminating in a cup holder having a generally recognizable character first shape, the cup holder capable of receivably accepting a geometrically shaped object.

4. The head rest body insertion post of claim 1, wherein the body insertion post further comprises a vertical channel through at least a portion of the elongated insertion end, capable of transmitting there through an anchor belt.

5. The head rest body insertion post of claim 1, wherein the position of the body insertion post in the top side of the seat body is adjustable in the vertical plane.

6. The head rest body insertion post of claim 1, wherein the body insertion post further comprises an insertion post vertical adjustment locking means.

7. The seat according to claim 1, wherein the top side of the seat body further comprises a vertical channel, having a channel upper end and a channel lower end, the vertical channel capable of receiving at least a portion of the elongated insertion end of the head rest body insertion post.

8. The seat according to claim 7, wherein the vertical channel is capable of transmitted there through an anchor belt.

9. The seat according to claim 7, wherein the seat further comprises a plurality of vertically disposed adjustment locking apertures.

10. The seat according to claim 7, wherein the channel lower end terminates in an anchor terminus aperture, capable of receiving an anchor belt terminus.

11. The seat according to claim 1, further comprising a seat base.

12. The seat according to claim 11, wherein the seat base further comprises a storage compartment.

13. The seat according to claim 11, wherein the seat base further comprises at least one cup holder.

14. The seat according to claim 11, wherein the seat base further comprises a wheelbase attachment mean.

15. The seat according to claim 1, wherein the seat body bottom side further comprises a wheelbase attachment means.

16. The seat according to claim 1, further comprising a leg base.

17. The seat according to claim 16, wherein the leg base is removable.

18. The seat according to claim 1, further comprising a wheel base.

19. The seat according to claim 18, wherein the wheel base is removable.

20. The seat according to claim 1, further comprising a fastenable seat restraint belt system.

21. The seat according to claim 20, wherein the seat restraint belt system is a 5-point seat belt harness.

22. The seat according to claim 1, further comprising an insertable accessory device, wherein the insertable accessory device is mounted to the seat by removably inserting an geometrically shaped attachment object extending forth from the insertable accessory device into at least one of the arm rest cup holders.

23. The seat according to claim 22, wherein the insertable accessory device is a tray table.

24. The seat according to claim 20, further comprising a quick release seatbelt system, capable of rapidly disengaging seatbelts, enabling rapid release of a child from the seat, wherein the quick release system comprises: (a) a quick release rod, capable of horizontally inserting through the seat belt restraint system, facilitating contiguity of the seat belt restraint system, so that when the rod is horizontally removed, the seat belt restraint system is not contiguous, the rod having a handle end portion, a straight middle length and a far end portion, the handle end portion bent at an angle approximately perpendicular to the straight middle length; and (b) At least one locking rib, the locking rib comprising a block body having groove there through, capable of insertably receiving the quick release rod horizontally through the groove, wherein the groove comprises a horizontal portion and a vertical portion arranged so that the rod can be aligned in the horizontal portion of the groove in the horizontal plane, thereby preventing movement of the rod in the vertical plane.

25. The seat according to claim 24, wherein the rod is cylindrical.

26. The seat according to claim 25, wherein the locking rib block body is situated on the backside of the seat body in an orientation wherein the vertical portion of the groove and the horizontal portion of the groove form a “T” shape.

27. The seat according to claim 26, wherein the rod is of sufficient tensile strength so that it is capable of supporting the seat belt.

28. The seat according to claim 1, wherein the head rest is adjustable in the vertical plane.

29. The seat according to claim 16, wherein the leg base height is vertically adjustable.
